(19) United States
(12) Patent Application Publication
(10) Pub. No.: US 2008/0090193 A1
(43) Pub. Date: Apr. 17, 2008

(54) Apparatus for heat treatment of materials and process for real time controlling of a heat treatment process

(76) Inventor: Frederick A. Soanes, Rochester, NY (US)

Correspondence Address: LAW OFFICE OF TRACY P. JONG, 2775 BUFFALO ROAD, SUITE 3, ROCHESTER, NY, 14624, US

(21) Appl. No.: 11/906,576

(22) Filed: Oct. 3, 2007

Related U.S. Application Data
(60) Provisional application No. 60/850,915, filed on Oct. 11, 2006.

(51) Int. Cl. G06F 19/00; F27B 9/40; G01C 3/08

(52) U.S. Cl. 432/45; 700/207; 356/4.01

(57) ABSTRACT

A programmable control unit with sensors capable of measuring heat treatment parameters. The programmable control unit is used to input workpiece heat treatment data, measure the true exposure data, compare the corresponding values, and generate the appropriate control signals that may be used to adjust the heat treatment parameters to optimize the heat treatment process.

### PRIORITY CLAIM AND CROSS REFERENCES TO RELATED APPLICATIONS

This application claims the benefit of priority from provisional application U.S. Ser. No. 60/850,915 filed on Oct. 11, 2006 in the name of Frederick A. Soanes. Said application is incorporated by reference in its entirety.

### FIELD OF INVENTION

This invention relates to a method and apparatus for heat treating materials, and specifically, to devices and methods for real time controlling of a heat treatment process.

### DESCRIPTION OF THE RELATED ART

This invention generally relates to heat treating of materials which includes, but not limited to, simple drying of an object where a solvent is being driven off, the drying of a solvent based coating system where molecular cross-linking does not occur, and to systems where molecular cross-linking does occur, as in, for example, epoxy and powder coating type of materials. Throughout this discussion the terms heat treatment, curing, and drying will be used interchangeably. The source of heat energy in this discussion will include electromagnetic radiation sources, non-electromagnetic radiation sources, and forced heated air (e.g., portable heat gun type of systems) It is understood that these terms may be used interchangeably keeping with the spirit of the invention.

Heat treatment of coatings and other materials is commonly utilized in many manufacturing processes. Many hobbyists also use these more sophisticated processes to achieve professional-looking results. Radiation curable materials include paints, adhesives, floor coatings, and other coatings. Hobbies utilizing radiation curable coatings include recreation vehicle finishing and vehicle restoration.

Radiation curing is often accomplished with an infrared radiation source. As known to those skilled in the art, the proper and effective curing of infrared curable materials requires material-specific temperature ranges and distances from radiation sources.

Thus, it is often necessary to measure the surface temperature of an article during heat treatment. It is also desirable to measure distance between the heat source and the workpiece prior to and during heat treatment to prevent an unsuitable distance from being attempted, which can cause scorching, “undercuring” which will unnecessarily lengthen treatment time. The data from the distance and temperature measurements may be used to manually or automatically reposition the heat source in a manner that heat treatment proceeds within the desired temperature and/or distance ranges.

While there are separate devices for measuring temperature and distance that are presumably adequate for their intended purpose, it is desired to have an apparatus that incorporates a heat source with a temperature sensor and distance sensor in one device. It is also desirable to have a programmable control unit that can compare predetermined treatment conditions exposure parameters to actual real time measurements during the treatment process. This may be accomplished with a single portable programmable apparatus with various sensors or, alternatively, with a detachable apparatus that mounts on a portable heat source.

### BRIEF SUMMARY OF THE INVENTION

In accordance with the present invention, there is provided an apparatus and a method for heat treating materials with a heat source. An apparatus of the present invention comprises a heat source, sensors capable of measuring heat treatment parameters, and a programmable control unit. The programmable control unit is used to input workpiece heat treatment data, measure the true exposure data, compare the corresponding values, and generates the appropriate control signals that may be used to adjust the heat treatment parameters to optimize the heat treatment process.

In accordance with the present invention, there is further provided an apparatus which includes a heat source such as an electromagnetic radiation source or a source of heated air. A programmable control unit is used to input a plurality of exposure parameters from an operator, and accept a plurality of sensor signals measuring, for example, the true heat treatment parameters. A comparator circuit or a CPU based logic circuit will compare the true heat treatment parameters to the plurality of exposure parameters entered into the programmable control unit, and will initiate a signal when at least one limit condition of the workpiece is exceeded. Sensor signal or sensor signals shall be defined as the output of system sensors in all formats, e.g. sensor's raw analog output to digital binary equivalent ready for CPU processing.

In accordance with the present invention, there is further provided a programmable control unit that accepts workpiece heat treatment data, measures the true exposure data, compares the corresponding values, and generates a signal that can be used to adjust the heat treatment parameters to optimize the heat treatment process. The heat treatment process exposure data is defined as a corrected or uncorrected sensor signal of a measured parameter (e.g., temperature or distance) during the heat treatment process. Such a programmable control unit is adaptable as an accessory that mounts on a portable heat source.

In accordance with the present invention, there is further provided a method for treating a workpiece with heat comprising applying a heat source and targeting at least one sensor at the workpiece; entering a plurality of heat treatment exposure parameters and corresponding threshold values into the programmable control unit; sampling the plurality of sensor inputs at a predetermined interval; determining if a threshold has been exceeded by calculating the differential between the sensor measured value and any stored values from the corresponding plurality of parameters entered into the programmable control unit; generating a signal where at least one threshold has been exceeded; activating a device such as digital or paper text, an audible alarm, a visual alarm, a vibratory alarm, or the like. In some aspects of this novel method, the signal can prompt the operator or automatically initiate a feedback signal, or a corrective signal to the input interface controlling the workpiece exposure data such as heat source intensity, distance from heat source to workpiece, exposure time, and the like, to correct the cause of the exceeded threshold issue. The feedback signal, also called a corrective signal in this application, is defined as a control signal generated the programmable control unit returned to the input to achieve the desired heat treatment control via corrective actions including adjustments to heat source intensity and the like.

In accordance with the present invention, there is further provided a database which possesses useful information regarding workpiece exposure data in addition to the aforementioned workpiece exposure data which includes optimal settings for specific workpiece geometries, workpiece thicknesses, material types, and heat treatable coating properties to be applied. The programmable control unit calculates a differential based on this database information. It is understood that this database can be contained or supplied in many forms including RAM, ROM, flash drives, internet download, computer network, and the like. As used in this specification, a differential is a measure of the magnitude between at least one incoming sensor signal and at least one limit condition that is either provided or calculated by the programmable control unit that assists in the identification of heat treatment exposure parameters and corresponding threshold values limits or boundaries being exceeded.

It is an object of the present invention to provide a programmable control unit is used to input a plurality of exposure parameters from an operator, and accept a plurality of sensor signals measuring the true heat treatment parameters and will initiate a signal when at least one limit condition of the workpiece is exceeded. As used in this specification, a limit condition is a predetermined value that triggers the signal generation circuit.

It is an object of the present invention to provide a programmable control unit that is adaptable as an accessory for mounting on a portable heat source.

It is an object of the present invention to provide a method and device for heat treatment where a signal can prompt the operator or automatically initiate a correction to the heat treatment parameters such as heat source intensity, distance from heat source to workpiece, exposure time, and the like.

It is an object of the present invention to provide a process and device to aid in the heat treatment process that obviates the limitations of the prior art.

It is yet another object of the present invention to provide a device that is portable, maneuverable and highly adaptive to a wide variety of heat treatable materials and articles.

It is an object of the present invention to provide a device that is sufficiently light and maneuverable to be easily configured and mounted in operative position by a user.

It is yet another object of this invention to provide a relatively simple device that has low costs of manufacturing with regard to labor and materials.

It is yet another object of this invention to provide a device that may be manufactured from known materials and conventional manufacturing methods.

It is yet another object of this invention to provide a relatively simple device that is economical from the viewpoint of the consuming public, thereby making each economically available to the buying public.

It is yet another object of this invention to provide the ability to monitor and control a heat treatment process in real time.

Thus, having broadly outlined the more important features of the present invention in order that the detailed description thereof may be better understood, and that the present contribution to the art may be better appreciated, there are, of course, additional features of the present invention that will be described herein and will form a part of the subject matter of the claims appended to this specification.

### BRIEF DESCRIPTION OF THE SEVERAL VIEWS OF THE DRAWINGS

The invention will be described by reference to the specification and the drawings, in which like numerals refer to like elements, and wherein:

FIG. 1 is a perspective view of a novel apparatus for heat treatment processes;

FIG. 2 is a perspective view of one embodiment an apparatus depicting a handheld heat gun as the heat source;

FIG. 3 is an orthogonal side view of the embodiment in FIG. 2;

FIG. 4 is a perspective view of an alternative embodiment of an apparatus for heat treatment processes;

FIG. 5 is an orthogonal front view of the embodiment in FIG. 4;

FIG. 6 is an exploded view of the embodiment depicted in FIG. 4;

FIG. 7 is an orthogonal side view of an alternative embodiment of an apparatus for heat treatment processes;

FIG. 8 is an orthogonal side view of an alternative embodiment of an apparatus for heat treatment processes;

FIG. 9 is an orthogonal side view of an alternative embodiment of an apparatus for heat treatment processes;

FIG. 10 is an orthogonal front view of one embodiment of a programmable control unit;

FIG. 11 depicts a graph for a heat treatable material;

FIG. 12 is a flow chart depicting the process of real time controlling of a heat treatment process;

FIG. 13 is a flow diagram of an alternate embodiment of a novel process for heat treating a workpiece by a heat source;

FIG. 14 is a flow diagram of a novel process for heat treating a large workpiece by a heat source; and

FIG. 15 is a perspective view of an alternative embodiment of an apparatus for heat treatment processes.

These drawings are not to scale, in fact, relative dimensions are exaggerated in order to facilitate particular features and relationships.

### DETAILED DESCRIPTION OF THE INVENTION

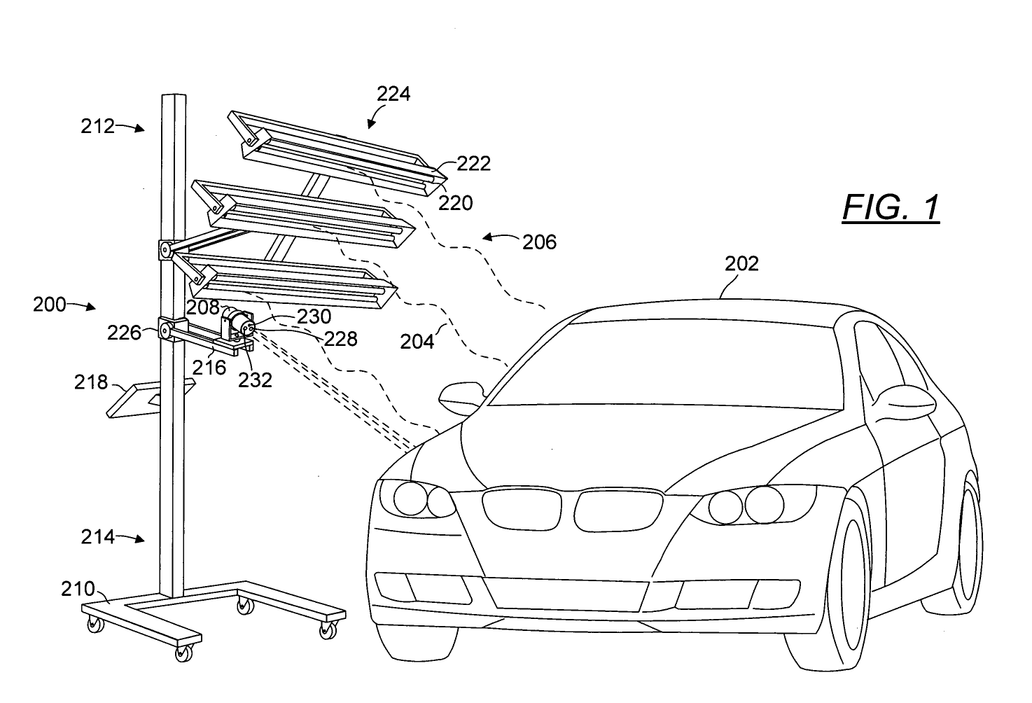

FIG. 1 depicts an isometric view of a novel apparatus 200 of the present invention in use. In the embodiment depicted, an infrared cure system 206 is assembled with a programmable control unit 218 temperature sensor 228 and distance sensor 232. In the aspect depicted, apparatus 200 is used to heat treat an automobile 202. Thus, the automobile is the workpiece in the illustrative embodiment.

An apparatus 200 for the heat treatment of materials comprises a heat source 206, a distance sensor 232 for measuring a distance from heat source 206 to workpiece 202, and a programmable control unit 218. The distance sensor 232 is operably connected to a programmable control unit 218. The programmable control unit 218 is configured for managing a plurality of exposure parameters and is operably connected to the heat source 206 (in this case, the infrared cure unit). Preferably, the programmable control unit 218 comprises a data input interface for entering workpiece 202 exposure parameters, a comparator circuit or a CPU based logic circuit, a timer circuit, and a signal generation circuit.

The comparator circuit defines at least one limit condition based on a plurality of incoming distance sensor 232 and temperature sensor 228 signals (e.g., workpiece surface temperature, distance, and the like) and the entered workpiece exposure data. The timer circuit measures the duration of time that the workpiece 202 is subject to the heat treatment process. The signal generation circuit generates a signal when at least one limit condition of the workpiece 202 is exceeded.

As used in this specification, a heat source 206 comprises a source of electromagnetic radiation (e.g. infrared or ultraviolet) or temperature controlled air (e.g. heat gun style products). As used in this specification, heat energy or radiation may also refer to ultraviolet, infrared, thermal, visible light energy, or heated air. Regarding radiation energy, the wavelength or frequency will depend upon the target material being cured. One preferred embodiment of the novel process and apparatus of this invention will be described using infrared energy, however, it is to be understood that application of this apparatus and process to other radiation and heat energies is considered to be within the scope of the present invention.

A workpiece 202 (commonly referred to as a substrate) comprises any object the user desires to heat treat (e.g., a wet metallic or polymer based substrate which requires simple drying, melting, or curing). Heat treatment may be desirable to facilitate a process, prevent oxidation, soften the material, melt ice, or the like. In particular, heat treatment is used during the application of an over-coating (e.g. a dry powder coating). Many coatings and adhesives require heat treatment in order to cure the coating and/or achieve the coating's optimum properties. Heat treatment is also commonly used during the application of wet spray coatings where the addition of heat energy will promote drying.

As used in this specification, curing or treatment may refer to the chemical curing of a material from a liquid state to a solid state upon exposure to heat energy after the material has been applied to an article, and includes processes where heat energy causes a chemical process selected from the group consisting of solvent evaporation, cross linking of monomers, catalysis of free radical polymerization of the target material, catalysis of polymerization of cationic cycloaliphatic epoxide target materials, catalysis of dual cure chemistries, and the like.

Radiation curing processes are well known in the art. Reference may be made to U.S. Pat. No. 6,740,352 (Method for forming bonding pads); U.S. Pat. No. 5,372,858 (Method and device for applying a plastic coating to woven yarn tubing); U.S. Pat. No. 6,855,070 (Infrared heating method for creating cure gradients in golf balls and golf balls cores); U.S. Pat. No. 5,853,215 (Mobile spray booth workstation); U.S. Pat. No. 6,858,669 (Plastic article with coating providing increased melting point and an increased temperature induced plastic flow characteristic); U.S. Pat. No. 6,899,752 (Latent image printing ink composition, prints containing latent images recorded with the ink composition, and latent image data-based deciphering method and latent image data deciphering device); U.S. Pat. No. 6,840,167 (Multi-color pad printing device and method); and the like. The disclosure of each of said patents is hereby incorporated by reference into this specification. Reference may also be had to, e.g., U.S. Pat. No. 5,536,758 (Ultraviolet Radiation Curable Gasket Coating Compositions); U.S. Pat. No. 6,048,749 (Fabrication Process of A Semiconductor Device Including Grinding of a Semiconductor Wafer); and the like. The disclosure of each of said patents is hereby incorporated by reference into this specification.

UV curing is used, e.g., in manufacturing processes such as curing headlight and taillight lenses and reflectors; applying stains, dyes, and scratch resistant coatings; curing magnetic media; printing applications such as magazines, labels, tags, book covers, corporate reports, brochures, and ceramics; automotive components, metal cans, silicone release materials, steel pipe, lacquering of wood furniture, and vinyl flooring; cosmetics and medication cartons, plastic cups, tubes, shampoo bottles, and plastic shopping bags; wood, glass and plastic finishing; metal decorating; fiber optics; UV glues; three-dimensional curing; CD manufacturing; electronics such as integrated circuits, optical fibers, and circuit boards; and other photopolymer applications.

In the ultraviolet (UV) curing process, photoinitiators are added to coatings, adhesives and inks. When the photoinitiator reacts with certain wavelengths of UV light, molecular linking occurs, creating a durable finish and superior adhesion to the article.

In the infrared (IR) curing process, electromagnetic waves are used in the same manner as UV light for curing. The infrared spectrum ranges from 0.76 to 10 microns (29.92 to 393.7 microinches), and is divided into three sub-ranges: short wave, medium wave and long wave or sometimes referred to as “IR-A, IR-B, and IR-C.” In one embodiment, infrared radiation comprises wavelengths of from about 780 to about 10,000 nanometers (about 30.71 to about 393.7 microinches). As known to those skilled in the art, IR is a line-of-sight technology, that is, an object must be in sight of the radiation emitter to be heated. This attribute makes IR particularly good in coating applications where an object needs to be heated only on a surface location. IR curing is used, e.g., in manufacturing processes such as curing inks, powder coatings; drying of parts; fine soldering; silk screening; latex and adhesive drying; annealing of rubber; shrink wrapping; molding plastics by blowing, vacuuming, rotamolding, or squeezing the plastic between calendar rolls; and textiles and paper to dry the product quickly and completely. Hobbyists also use IR for curable coatings for automotive and dune buggy surfaces.

Radiation curable coatings are designed to cure when exposed to one or more specific wavelengths of ultraviolet (UV), electron beam (EB) or infrared (IR) radiation. Ultraviolet light is a type of radiation that activates an initiator in a specially formulated coating to start a free-radical polymerization reaction. Electron beams, also known as beta rays, are an energy source that cures special coatings with high-energy electrons to cause a cross-linking reaction. Infrared radiation is absorbed by many coatings systems, causing frictional (vibrational) heating of the coating molecules and initiating solvent evaporation or film cross-linking.

Referring again to FIG. 1, a programmable control unit 218 is operably connected to a distance sensor 232 to measure the approximate distance between the object 202 and the heat source 206. The programmable control unit 218 is central to the system's operation. All sensor inputs are relayed to the programmable control unit 218. Additionally, all data regarding the system's operation is entered into the unit 218. The programmable control unit 218 uses one or more algorithms, which are known, are presently being developed, or will be developed in the future.

The programmable control unit 218 may comprise any one of the many commercially available programmable controllers, programmable logic controllers (PLC), or CPU based logic circuit that receive signals from and transmit signals to field mounted devices that are known in the art. As used in this specification, CPU shall mean a microprocessor chip which interfaces with input and output devices. As used in this specification, a CPU based logic circuit shall mean a CPU microprocessor with additional elements comprising one or more ROMs (read only memory), RAMs (random access memory), wireless cards, network interface cards, and the like. As used in this specification, nonvolatile memory shall mean a memory that will retain its contents in a situation where there is no external power supplied to the system.

In one embodiment, the programmable control unit 218 includes a control console having a display and other user interface devices such as a power switch and buttons for entering information into the system. It also has a programmable digital controller and associated circuit board containing switching circuitry that, in combination, transmit control signals to the field sensors and generate a signal indicating one or more exposure parameters is outside of a threshold value range.

Data input interfaces for the programmable control unit 218 may take a variety of forms including direct hardwire for downloading data, fiber optics, wireless communication devices, and direct human machine interfaces (HMI) such as keyboards, numeric keypads, pushbutton style displays, and the like.

The programmable control unit 218 may be coupled to an output module operably connected with one of a plurality of output devices. By way of illustration, these devices include, among others, a light emitting device, a sound emitting device, a vibration inducing device, a printer, a display, and a network interface card.

Distance sensors 232 are well known in the art for measuring a distance from an object to a sensor and a variety of prior art laser based distance sensors may be suitably used with the present invention. By way of illustration, a distance sensor substantially similar to STANLEY™ 77-910-TLM 100 FATMAX TRU-LASER™ Distance Measurer, STRAIT-LINE™ SONIC LASER TAPE 50,™ has been adapted for use with the present invention.

In the embodiment depicted, a programmable control unit 218 is also operably connected to a noncontact temperature sensor 228 to measure the surface temperature of a workpiece 202 during heat treatment. Noncontact temperature measuring devices or thermal sensors 228 are well known in the art for remotely measuring a surface temperature of an object 202 and a variety of prior art based on thermal infrared sensors may be suitably used with the present invention. By way of illustration, a noncontact thermal sensor substantially similar to the one manufactured by RAYTEK™ MX Series Precision Infrared Thermometers and/or Thermalert Series, or MEGASCOPE™ has been adapted for use with the present invention. By way of further illustration, a noncontact thermal sensor substantially similar to Cen-Tech Non Contact Laser Thermometer Model 91778 distributed by Harbor Freight Tools, 3491 Mission Oaks Blvd., Camarillo, Calif. 93011 has been adapted for use with the present invention.

The incoming sensor signals are provided to the programmable control unit 218 by one or an array of system sensors including temperature sensor 228 and distance sensor 232 having an exposed surface for capturing, for example, distance and surface temperature measurements. In a preferred aspect of this invention, the programmable control unit 218 includes a distance sensor 232 and a noncontact type temperature sensor 228.

Continuing to refer to FIG. 1, an operable connection between the distance sensor 232 and the programmable control unit 218 may be established in a variety of manners, including but not limited to hardwired cable, fiber optic, wireless communication connections, and the like. In the embodiment depicted, an operable connection is established with hardwired cable (not depicted).

A bilateral signal connection (e.g. interrupt, polling and the like) between the distance sensor 232 and the programmable control unit 218 will permit exposure data to be received by the programmable control unit 218 from the laser distance sensor 232, signal converter, signal conditioner, A to D (analog to digital) converter, and the like. A distance sensor, including a laser distance sensor will mean an electronic system where the distance between the sensing unit and the object of interest is determined by measuring the time of transmission to and from it. Similarly, exposure data from temperature sensor 228 and other sensors may be received by the programmable control unit 218 via corresponding bilateral connections with temperature sensor 228 and the like.

Referring to FIG. 1, the power needs of the system are supplied by the programmable control unit 218 via hardwired cable, battery, or other means known in the art. In the embodiment depicted, the power needs of the system are supplied by the programmable control unit 218 via hardwired cable (not depicted).

In one embodiment, the programmable control unit 218 manages a plurality of exposure parameters and is operably connected to the heat source 206. As used in this specification, exposure parameters are those factors that are monitored and/or controlled during the heat treatment process. Preferably, they are those factors affecting the output quality of the heat treatable coating. Other factors useful to a user of the system, although not directly affecting coating quality or characteristics, may also be monitored (e.g., process costs, coating material costs, system energy usage, and the like. Any parameter desired by the user may be managed by the programmable control unit 218, including for example, an optimal surface temperature of a workpiece, a minimum surface temperature of a workpiece, a maximum surface temperature of a workpiece, a target surface temperature of a workpiece, an optimal exposure time of a workpiece to the heat source, a minimum exposure time of a workpiece to the heat source, a maximum exposure time of a workpiece to the heat source, a target exposure time of a workpiece to the heat source, an optimal temperature of the heat source, a minimum temperature of the heat source, a maximum temperature of the heat source, a target temperature of the heat source, an optimal distance between a workpiece and the heat source, a minimum distance between a workpiece and the heat source, a maximum distance between a workpiece and the heat source, a target distance between a workpiece and the heat source, the emissivity value of a workpiece, a deviant percentage value from any optimal, minimal, maximum or desired parameter, an interval sampling rate for the reading of said at least one sensor. The interval sampling rate shall mean the number of times a data channel is polled for information in a one second period, for example a temperature sensor with an interval sampling rate of five, will have its data channel polled 5 times in a one second period.

One parameter of significance for heat treatment processes is an emissivity value of the workpiece (including any coatings applied thereto for treatment). In one preferred aspect, an emissivity value is used to correct an incoming infrared surface temperature sensor signal to provide a true workpiece surface temperature output reading. The workpiece surface temperature is defined as the measure of the heat energy mainly residing in the heat treatable coating and substrate surface area, and the true workpiece surface temperature output reading is the actual temperature or thermal energy level present in the heat treatable coating and substrate surface area interface.

Material surfaces emit thermal radiation. At a specific temperature, isolating and measuring a specific thermal radiation wavelength emitted from a material will differ from the expected ideal radiation output. An ideal material is given a unit-less emissivity factor of one, and requires no correction. Since no material is ideal in this respect, working with emissivity factors of less than one is commonplace, and it is therefore expected that uncorrected IR sensor read measurements will be lower than the true temperature of the material. For example, if a material emits 25% of its theoretical value at a given wavelength and frequency, it is given an emissivity value of 0.25. An uncorrected IR sensor will always measure a lower temperature value than the actual object temperature, and therefore requires correction. The emissivity value comprises one of a few factors that are used in the calculation of the correction factor. The methods and apparatus involved in determining the emissivity and the correction factor are well known in the art.

The programmable control unit 218 comprises a comparator circuit or a CPU based logic circuit for comparing two corresponding values, either in digital or analog form, and determines whether two values are equal or unequal. Preferably, the programmable control unit 218 further determines which of the two values compared is larger or smaller in the unequal condition. The two corresponding values may include incoming sensor signals, stored data entered into the programmable control unit 218 via the user interface, and values generated by the programmable control unit 218 derived from processing or calculating a value based upon the foregoing. These values are processed by the comparator circuit, or CPU based logic circuit subsystem of the programmable control unit 218, to determine the comparative condition with respect to the heat treatment parameter limit condition or limit conditions entered.

The plurality of exposure parameters measured via sensors and entered into the user interface of the programmable control unit 218 will be converted to a CPU compatible format to enable comparisons and computations utilizing one of many commercially available CPU based logic systems, or CPU based logic circuits, known in the art for the comparator type tasks and calculation type functions. Furthermore, such a CPU based logic system is capable of generating the derived values from processing values generated or calculated from entered exposure parameters entered into the programmable control unit's 218 generated values. Such calculated values will already be in the preferred binary based format for any subsequent calculations desired.

The programmable control unit 218 may receive data input via a user interface or incoming sensor signals for a plurality of exposure parameters as desired by the user. By way of illustration, but not limitation, exposure parameters may include an optimal surface temperature of a workpiece, a minimum surface temperature of a workpiece, a maximum surface temperature of a workpiece, a target surface temperature of a workpiece, an optimal exposure time of a workpiece to the heat source, a minimum exposure time of a workpiece to the heat source, a maximum exposure time of a workpiece to the heat source, a target exposure time of a workpiece to the heat source, an optimal temperature of the heat source, a minimum temperature of the heat source, a maximum temperature of the heat source, a target temperature of the heat source, an optimal distance between a workpiece and the heat source, a minimum distance between a workpiece and the heat source, a maximum distance between a workpiece and the heat source, a target distance between a workpiece and the heat source, the emissivity value of a workpiece, elapsed exposure time, a deviant percentage value from any optimal, minimal, maximum or desired parameter, and an interval sampling rate for the reading of a sensor.

The limit conditions provide the boundaries of acceptable heat treatment values which enable the heat treatment process to function within its acceptable or desirable limits. The limit conditions are dictated by factors including thermal characteristics of the workpiece, finishing product or coating material. By way of illustration, the target value, upper and lower limit condition values, and upper and lower threshold limit for a material being heat treated could obtained from the manufacturer's specification on the material, industry standard values, published materials, computer model generated data, to name a few.

Thus, the programmable control unit's comparator circuit or CPU based logic circuit would make a comparison of the temperature signal received from a noncontact thermal sensor 228 with the exposure parameter values for temperature (e.g. a range or upper and lower temperature values) entered in the user interface of the programmable control unit 218. The limit condition values for temperature may be the exposure parameter values for temperature that were entered in the programmable control unit 218 or a value derived there from (e.g., a median or average value). In one aspect, these upper and lower limit condition values are at the extreme edges of the time-temperature exposure where thermal material damage begins on the upper side, and heat treatment ceases on the lower side. The limit conditions would be exceeded when associated temperature derived from the signal resides either above or below the upper and lower limit condition values.

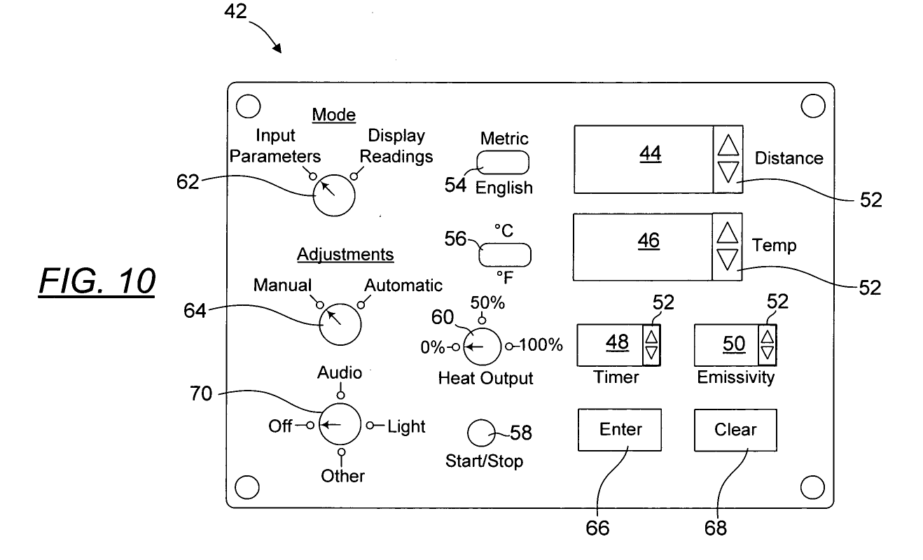

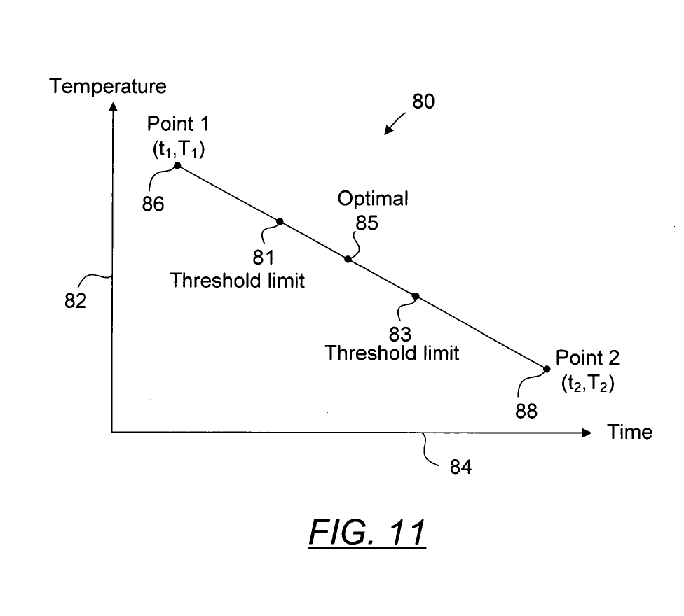

Referring to FIG. 11 and the graph 80 depicted, the Y-axis 82 represents temperature, and the X-axis 84 represents time. The graph 80 reveals the acceptable time-temperature relationships and acceptable ranges for heat treating a given heat treatable material. The time-temperature points depicted are the upper limit value 86, lower limit value 88, upper threshold limit 81, lower threshold limit 83, and optimal point 85. These exposure points are suitable data for programming into the control panel interface 42, or will also be referred to as a data input interface of FIG. 10. The control panel interface 42 or data input interface shall be defined as the system interface enabling an operator to manually or electronically input exposure parameters and other data into the programmable control unit 218. With such data the control panel is able to not only detect out of range workpiece surface temperatures by the well known techniques, but can also automatically adjust or call for an adjustment of one or more of the heat treatment exposure factors including the workpiece exposure time, workpiece surface temperature, and distance from heat source to workpiece to ensure proper exposure of the workpiece.

FIG. 11's time-temperature graph may be used to determine threshold limits or limit conditions. A limit condition is defined as the utmost extent within a given boundary condition. The threshold limits serve to help maintain the desired temperature range on the surface of the workpiece about the optimal temperature point depicted in the time-temperature graph of FIG. 11. This less generous range will help reduce the probability of the exposure reaching the aforementioned undesirable upper and lower limit condition values located at the extreme edges of the time-temperature exposure graph of FIG. 11. The threshold value or values are understood to define both desirable and undesirable limits and boundaries for the heat treatment process, and can be obtained by variety of methods. Such methods include calculating a range above and below the optimal value based on the magnitude of the optimal value, fixed values that can be entered or downloaded, and the like. For example, given an optimal operating point of 100 seconds at 400 degrees F., a temperature 10% swing will yield threshold limit from 360 to 440 degrees F. In most heat treatment scenarios there exists enough latitude to enable the precision of control to vary without consequence. For example, a temperature of a surface being heat treated being controlled within three degrees above and below target temperature is considered adequate for most applications.

Referring again to FIG. 1, the programmable control unit 218 further comprises a timer circuit that measures the duration of time that the workpiece 202 is subject to the heat treatment process. The timer circuit is set to a particular value when entering exposure parameters into the programmable control unit 218, but can be changed as long as the time-temperature relationship is maintained as in FIG. 11. For example, if one is heat treating a coating on a plastic substrate, opting for a lower temperature at the expense of a longer exposure time may be desired.

The comparator function of the programmable control unit 218 can be accomplished by apparatus and methods well known in the art, including comparator circuits, programmable logic controllers, and other CPU based logic circuit systems. When a comparison test has failed, a flag condition is generated followed by the generation of a signal from the programmable control unit 218. This signal will activate an alarm type function which includes, but is not limited to an audible, visual (e.g., light or LED), vibratory or the generation of additional output signals.

In one aspect of the programmable control unit 218, a database is accessed from which threshold limits of exposure parameters are generated therefrom. The database contains exposure parameter data stored in a memory of the programmable control unit 218. The database may be populated with data via the user interface, incoming sensor signals, or generated from algorithms based upon either or both of the foregoing.

Referring again to the time-temperature relationship of FIG. 11, given a specific functional heat source to workpiece distance, we can locate an optimal exposure point 85. Between the upper threshold limit 81 and lower threshold limit 83 there exists many valid time-temperature operation points where the heat treatment process can be safely run, that, is where the heat treatment process does not cause deterioration or damage to the workpiece. This can be referred to as the optimum zone. Between the upper limit value 86 and the upper threshold limit value 81, and also between lower limit value 88 and the lower threshold limit value 83, the system is operating out of the optimal range; this can be referred to as the cautionary zone where caution should be exercised. Beyond the upper threshold limit 81 and the lower threshold limit 83 values, the exposure conditions are beyond the operating range of the workpiece and/or heat treatment equipment. Working in this range will run the risk of causing heat related damage to the workpiece, or creating a condition where an excessive amount of time to complete the heat treatment process, or producing a product that is incompletely or not cured (or heat) treated at all.

Given an example where the workpiece surface temperature is measured above either the upper threshold limit 81 or upper limit value 86, the programmable control unit 218 system can compensate in several ways. The correction options can be either manual or automated, and include flagging the operator to alert them of the concern, adjusting the output intensity or power output of the heat source, adjusting the workpiece- to-heat source distance, or adjusting the workpiece exposure time. One or more of these is more easily adjusted via automated control using the programmable control unit 218.

The operator has several options regarding educating the programmable control unit to the workpiece's acceptable and unacceptable operating ranges. One method is to input an optimal exposure point 85, with a corresponding percent deviation value which will automatically generate the threshold limit values 81 and 83. Additionally, the upper and lower threshold limits, points 81 and 83 can be distinctly entered separately, either with or without an optimal exposure point 85. In this scenario, nonsymmetrical upper and lower threshold limits about the optimum value can be achieved. This system of exposure control created tri-state type of feedback and control where the operator and or control system is presented with an optimal exposure condition, an acceptable exposure condition, or an unacceptable condition where the system is outside of the acceptable exposure condition.

Referring again to FIG. 1, in one aspect of apparatus 200, it is adapted for curing an infrared curable coating on a workpiece 202. In the embodiment depicted, the distance sensor 232 for measuring a distance from the heat source 206 to the workpiece 202 is incorporated in a sensor probe 208 that also houses other sensors 228 and component system parts.

In FIG. 1, the workpiece 202 comprises an automobile. As depicted, radiation waves 204 is emitted from device 206 toward automobile 202. Automobile 202 is coated with an infrared curable coating that cures upon exposure to infrared radiation for a specified time. In the embodiment depicted, novel apparatus 200 comprises sensor probe 208, infrared cure lamps 206 and stand 210.

In the embodiment depicted in FIG. 1, stand 210 comprises a conventional support member base with wheels. Stand 210 comprises a first end 212 and a second end 214. First end 212 is adapted for mounting to an infrared radiation lamp 206. In one embodiment, second end 214 of stand 210 is adapted to be placed on the floor.

Many stand configurations are adaptable to be used with the present invention. By way of illustration, but not limitation, several embodiments will be described (but not shown). In one embodiment, second end 214 of stand 210 is adapted to be mounted to another object. In one embodiment, stand 210 comprises wheels at second end 214. In one embodiment, stand 210 is collapsible when not in use. In another embodiment, stand 210 is permanently mounted to the floor.

In one embodiment, stand 210 preferably comprises a material that is durable and rigid enough to support the weight of the infrared cure lamp 206, sensor probe 208, mounting bracket 216, and programmable control unit 218.

In one aspect, stand elements sections 210, 212, and 214 are comprised of a material that is capable of withstanding heat with temperatures of at least 500 degrees Fahrenheit (260 degree Celsius). In one aspect, stand 210 comprises a material that is capable of withstanding corrosion when contacted with paints, adhesives and solvents.

Referring again to FIG. 1, a heat source 206 comprises a plurality of infrared cure lamps, each respectively comprising heating element 220 and a shroud 222. In one embodiment, shroud 222 reflects infrared radiation toward the cure target, e.g., automobile 202. In one embodiment, heating elements 220 comprise coils. In another embodiment, heating elements 220 comprise bulbs.

In one embodiment, infrared cure lamp 224 is a unitary structure commercially available as a unit. By way of example, but not limitation, one may use infrared light cure system part #10170 distributed by the Eastwood Company, 263 Shoemaker Road, Pottstown, Pa. 19464.

In one embodiment, infrared cure lamps 206 and stand elements sections 210, 212, and 214 are combined into a unitary structure.

In one embodiment, sensor probe 208 comprises a mounting bracket 216. In the embodiment depicted, mounting bracket 216 further comprises a vertical pivotable adjusting element 226. In one aspect, sensor probe 208 further encloses a laser pointing device 230, calibrated such that the laser pointing device 230 assists in the aiming calibration of temperature sensor 228 and distance sensor 232 onto the workpiece 202. In one embodiment, sensor probe 208 unit is insulated to protect sensor probe 208 components which include temperature sensor 228, distance sensor 232, and laser pointing device 230 from heat damage.

In the embodiment depicted in FIG. 1, a programmable control unit 218 is electrically connected to infrared cure lamps 206, sensor probe 208, temperature sensor 228, distance sensor 232, and power supply (not shown). Referring again to FIG. 1, power supply (not shown) comprises a standard power supply capable of delivering enough power to operate the components. Referring again to FIG. 1, sensor probe 208 encloses a temperature sensor 228 and a distance sensor 232, laser pointing device 230, calibrated such that the laser pointing device 230 assists in the aiming calibration of sensors 228 and distance sensor 232 onto the workpiece 202. In one embodiment, one may use an ultrasonic, infrared or laser type distance sensor as the distance sensor 232.

In an alternative embodiment of the novel apparatus 200, the heat source 206 comprises a source of adjustable electromagnetic radiation defined as a option where the output intensity of the heat source may be selectively adjusted by the user or the programmable control unit. By way of illustration, an infrared heat lamp with output at 200 watts, 300 watts, 400 watts, and the like.

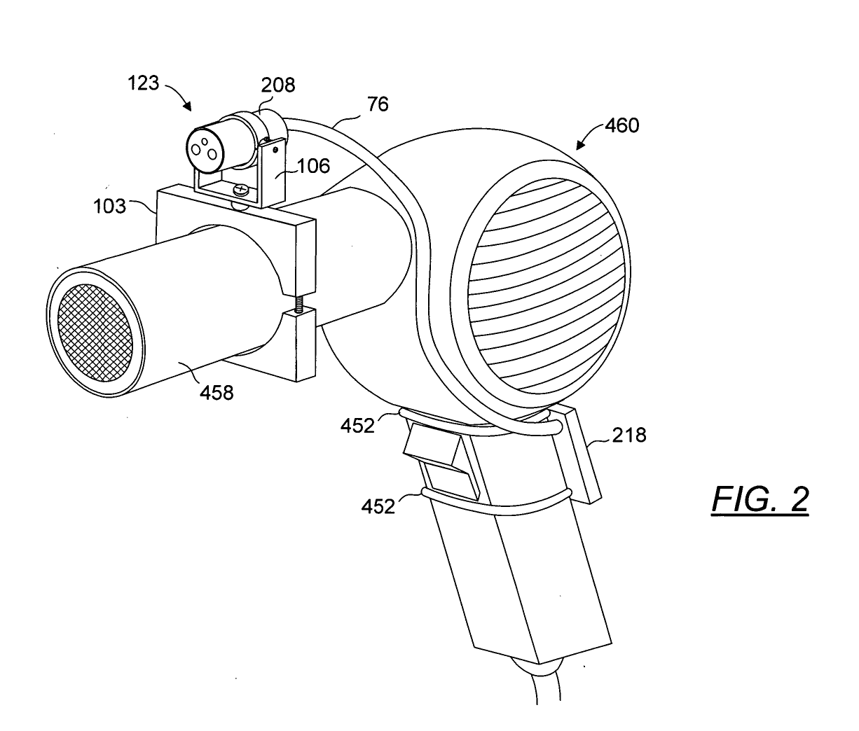

In an alternative embodiment of the novel apparatus 200, the heat source 206 comprises a source of temperature controlled air. In a preferred embodiment, a source of temperature controlled air is a heat gun as depicted in FIGS. 2, 3 and 7.

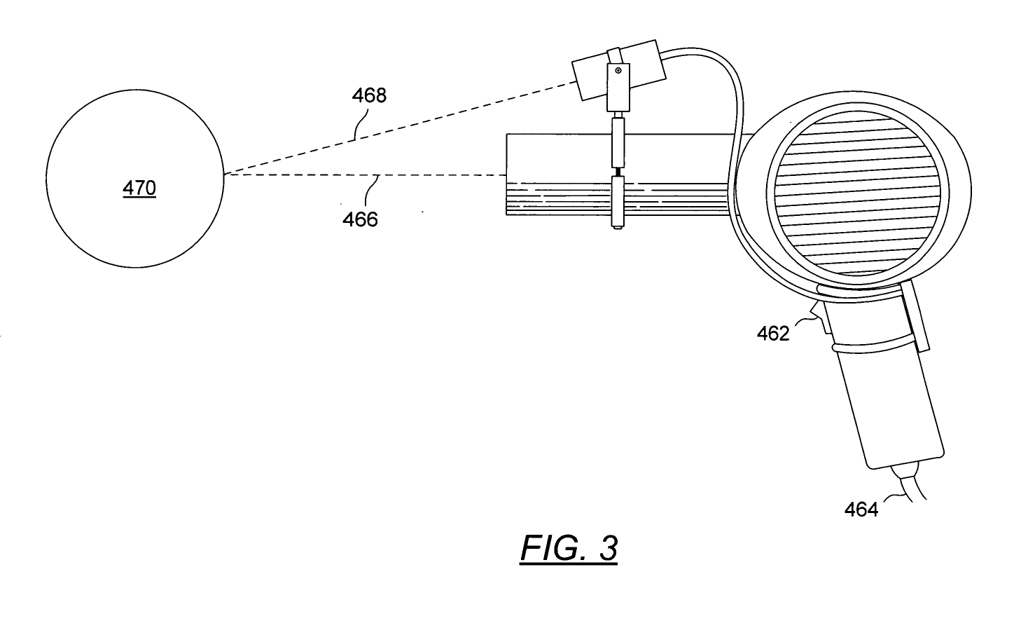

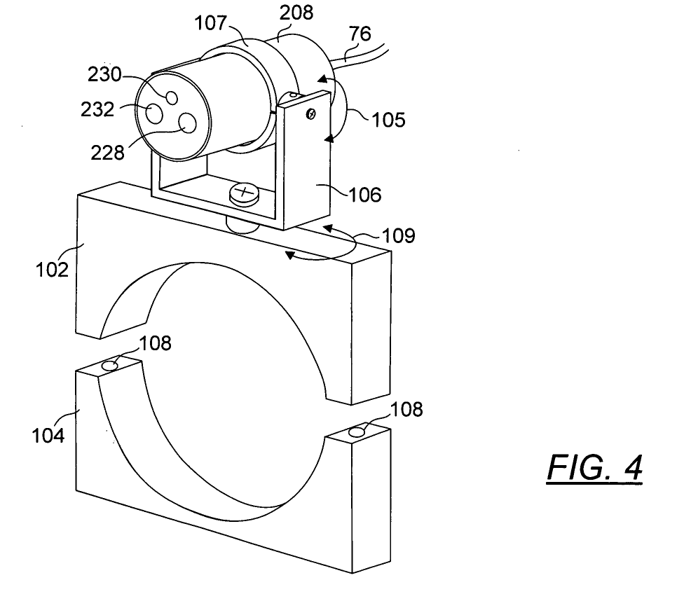

FIG. 2 is an isometric view of one embodiment of a heat gun 460 with a sensor probe 208, a programmable control unit 218 and a heat gun mounting bracket 103. FIG. 3 is an orthogonal side view of the embodiment depicted in FIG. 2 with a workpiece depicted. FIGS. 4, 5 and 6 depict the sensor probe 208, a programmable control unit 218 and a heat gun mounting bracket 103 and a probe clamp assembly 123 for use on heat gun barrel 458.

Referring to FIG. 2, the heat source comprises a heat gun 460. A distance sensor is provided in a sensor probe 208 as previously described. The sensor probe 208 is operably connected to a programmable control unit 218.

In the aspect of the embodiment depicted in FIGS. 2 and 3, a programmable control unit 218 is removably affixed to the handle of a heat gun 460 with display mounting straps 452, and operably connected to sensor probe 208 via cable 76. The sensor probe horizontal mounting bracket 106 is affixed to a heat gun mounting bracket 103 about the barrel 458 of the heat gun 460. Present is an on-off switch 462, a power cord 464, and an electrical power/control cable (not shown) from the sensor probe 208/programmable control unit 218 assembly electrically connected to the heat gun 460. Referring to FIG. 3, a sensor signal 468 is emitted in the direction of workpiece 470 simultaneous with the application of hot air 466 from the heat gun.

In one embodiment, a heat gun bore alignment tool aids in centering the sensor probe 208 to the center of the heat area.

In one embodiment, a cap (not depicted) is removably affixed about the end of the heat gun 460 and/or sensor probe 208 when not in use.

Referring to FIG. 4 and the embodiment depicted, sensor probe 208 comprises two sensors 228, 232 and a laser pointing device 230 and is adapted to target and measure surface temperature of a workpiece and measure distance from a workpiece. Cable 76 operatively connects sensor probe 208 to a programmable control unit 218 and/or a power supply.

In one aspect of this embodiment sensor probe 208 has a cylindrical housing with a round cross-section. In another embodiment (not shown), sensor probe 208 has a square cross section. In another embodiment (not shown), sensor probe 208 has a non-geometric cross section.

Again referring to FIG. 4 and the embodiment depicted, sensor probe 208 is releasably attached to the probe mounting bracket 107. Mounting bracket 107 is releasably attached to the sensor probe horizontal mounting bracket 106 to enable sensor probe 208 to pivotally move in an upward and downward direction 105, enabling sensor probe 208 to accurately focus on a workpiece.

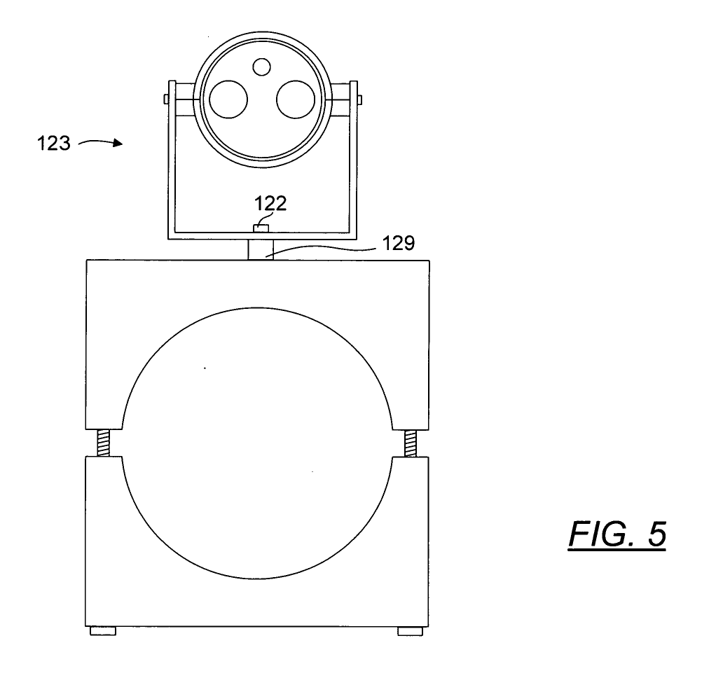

Referring to FIGS. 4 and 5, probe clamp assembly 123 has a pivoting collar 129 to facilitate adjusting the sensor probe horizontal mounting bracket 106 in the (X-Z directions) direction 109. This feature will allow the user to more precisely focus the laser pointing device 230 and sensors 228, 232 upon a workpiece.

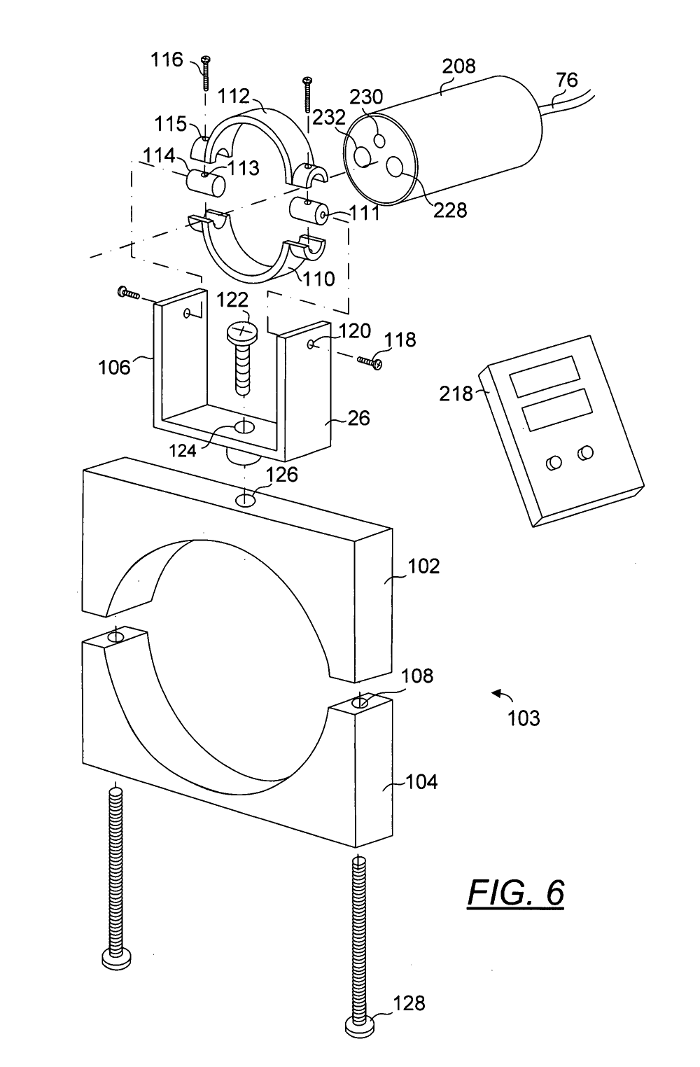

Referring to the embodiment depicted in FIG. 6, apertures 108 and 124 are mounting screw through holes to accommodate the insertion of mounting screws 128 and 122, respectively. There is a corresponding mounting screw through holes on top member of accessory mounting clamp (not shown). These holes on top and aperture 126 are both threaded to receive the corresponding mounting screw.

Referring to FIG. 6 and the embodiment depicted, top member 112 of probe mounting bracket, including apertures 115 to accommodate corresponding mounting screw 116, is connected to bottom 110 member of probe mounting bracket possessing threaded apertures (not shown), via connecting cylinders 114 having screw apertures 113 for screws 116 and threaded apertures 111 to accommodate screws 118. In one embodiment, said threading comprises ¼-20 threads.

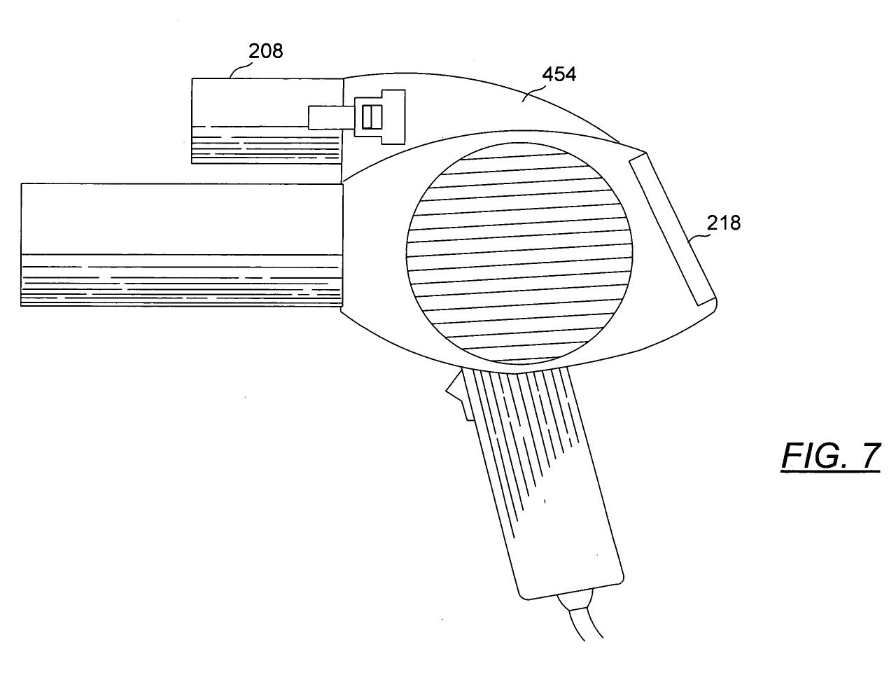

FIG. 7 depicts a heat gun 454 that is adapted to be integrally formed or removably coupled (e.g. snap-on or screw-on) with a sensor probe 208 and a programmable control unit 218. In this adapted heat gun 454, sensor probe 208 and programmable control unit 218 plug into a specifically designed docking ports which automatically engage all the proper signal and power connections.

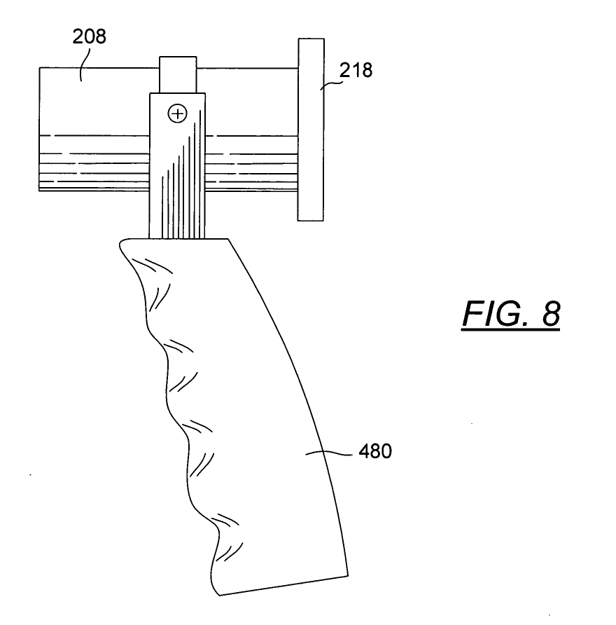

FIG. 8 depicts a handheld probe device with a laser device for measuring distance from a heat source to an object and an infrared temperature measuring device for measuring a surface temperature of an object. Handle 480 is affixed to sensor probe 208 and programmable control unit 218. Handle 480 is adapted to accept batteries or a power cord (not depicted). The probe, programmable control unit, laser device and infrared temperature measuring device are substantially the same as disclosed and described with respect to FIGS. 1-7.

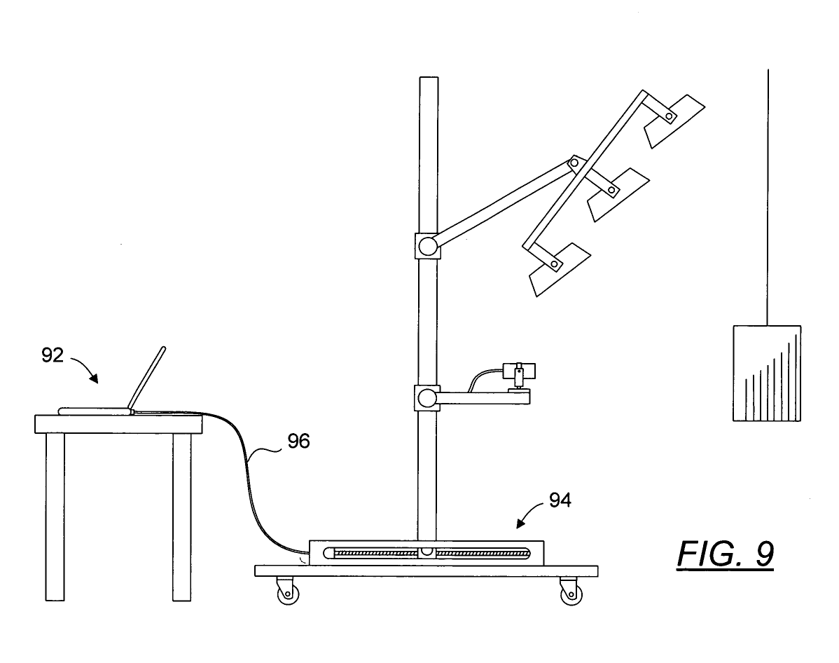

FIG. 9 is an isometric side view of an alternative embodiment of an apparatus for heat treatment processes. Referring to FIG. 9 and the embodiment depicted, a motion controller 92 is electrically connected to an apparatus for linear motion 94 via a signal and/or power cable 96. The motion controller 92, apparatus for linear motion 94, as well as required hardware and software accessories are well known in the art. A wide variety of component designs can be used to accomplish the objective of the embodiment. For example, apparatus for linear motion 94 can be accomplished by wheel guided belt driven, ball screw wheel guided, or ball screw slide guided type designs to name a few. By way of illustration, but not limitation, devices that may be suitably used with the present invention include those available via Danaher Motion's product line. Danaher Motion located at 1500 Mittel Blvd. Wood Dale, Ill. 60191 USA, offers an extensive selection of components to create such a linear motion controlled system including the motion controller 92 and apparatus for linear motion 94. The heat source to workpiece distance can be adjusted utilizing these elements and be initiated either manually or by the programmable control unit 218.

FIG. 10 depicts a front view of one embodiment of programmable control unit 218, and control panel interface 42. The plurality of displays 44, 46, 48, 50 and provide an output corresponding to signal data received from a plurality of sensors shown in sensor probe 208 in FIG. 1. By way of illustration, but limitation, LCD displays 44, 46, 48, 50 and associated label, provide readings for distance 44, temperature 46, time 48 and emissivity 50.

In the embodiment depicted, control panel interface 42 comprises a plurality of displays 44, 46, 48, 50, and a plurality of control buttons, knobs, and/or switches, and their associated close proximity labels: 52, 54, 56, 58, 60, 62, 64, 66, 68, 70. The displays may be LCD, LED or the like.

Referring again to FIG. 10 and the embodiment depicted, increase/decrease value buttons 52 corresponds to all displays (e.g., display 44 for distance programming and reading). Switch 54 is a user activated toggle switch used to select between metric (meters or centimeters) and the English standard (feet or inches) input/output values. Switch 56 corresponds to LCD display 46 for temperature measurements/programming and comprises a user activated toggle switch to select between metric (Celsius) and English (Fahrenheit) systems.

Referring again to FIG. 10 and the embodiment depicted, associated button 52 is selectively depressed by a user to increase/decrease exposure duration on the timer LCD display 48. Associated button 52 is selectively depressed by a user to increase/decrease the emissivity values on the LCD or like display 50. Start/stop button 58 is used to start or stop workpiece exposure. Heat output control knob 60 allows a user to manually adjust exposure heat source intensity.

Referring again to FIG. 10 and the embodiment depicted, mode knob 62 enables a user to select either programming mode or standard display mode for displays 44, 46, 48, and 50. Adjustment switch 64 allows a user to select between allowing programmable control unit 218 to control exposure parameters or enabling a user to manually control the exposure parameters. Enter button 66 is used to enter values and move to the next step when inputting data or programming into programmable control unit 218. In the embodiment depicted, the clear button 68 is used to cancel an entry and enable re-entry of data. Selector switch 70 allows a user to select an output function during an alarm condition including “audio,” “lights,” “other,” and “off” options.

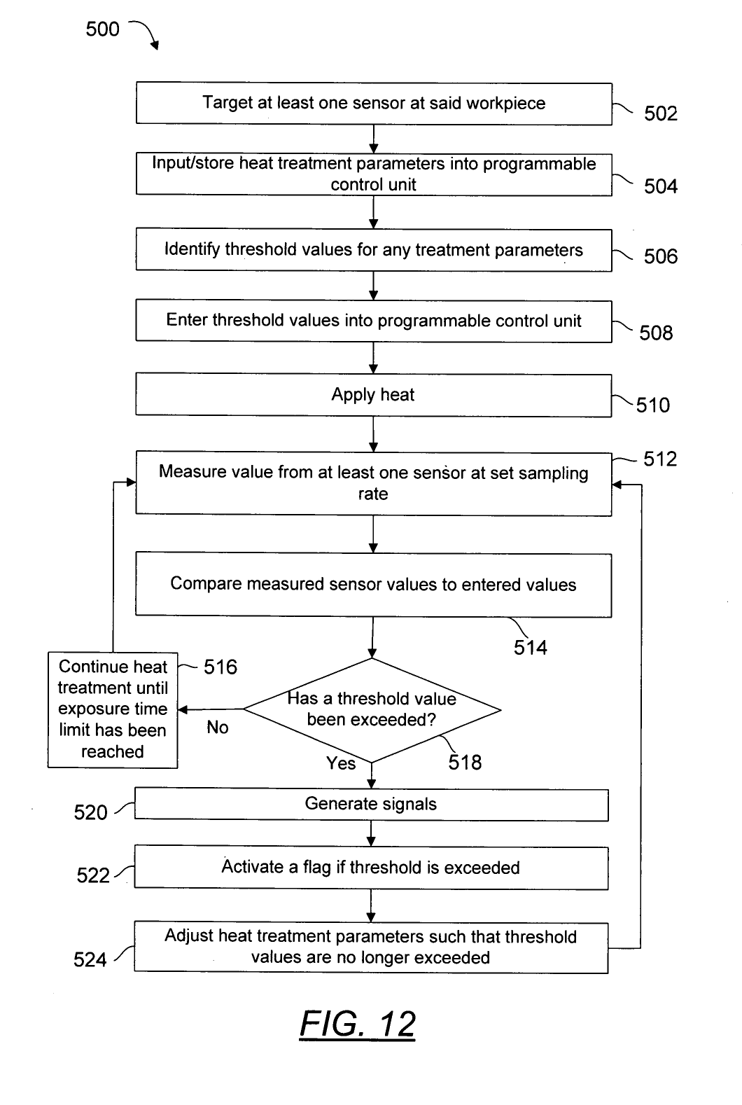

FIG. 12 is a flowchart representing a method of heat treating a workpiece that may be employed in accordance with embodiments of the present invention. This diagram is merely an example which should not limit the scope of the claims herein. One of ordinary skill in the art would recognize many other variations, modifications, and alternatives.

Referring to FIG. 12, process 500 is a process for real time controlling of a heat treatment process comprises the steps of:

In step 502 of process 500, least one sensor is targeted at a workpiece. In step 504, a plurality of heat treatment parameters are entered for storage into the programmable control unit. Entered for storage will provide the understanding that the plurality of heat treatment parameters will be in the memory of the programmable control unit (internal or external) and will be in, or converted to, a form where mathematical computations are enabled. The plurality of parameters includes one or more of: an optimal surface temperature of workpiece, a minimum surface temperature of said workpiece, a maximum surface temperature of workpiece, a target surface temperature of workpiece, an optimal exposure time of said workpiece to the heat source, a minimum exposure time of said workpiece to the heat source, a maximum exposure time of said workpiece to the heat source, a target exposure time of said workpiece to the heat source, an optimal temperature of said heat source, a minimum temperature of said heat source, a maximum temperature of said heat source, a target temperature of said heat source, an optimal heat source output intensity (wattage), a minimum heat source output intensity (wattage), a maximum heat source output intensity (wattage), a target heat source output intensity (wattage), an optimal distance between said workpiece and said heat source, a minimum distance between said workpiece and said heat source, a maximum distance between said workpiece and said heat source, a target distance between said workpiece and said heat source, an emissivity value of workpiece, a deviant percentage value from any optimal, minimal, maximum or desired parameter, and an interval sampling rate for the reading of at least one sensor.

In steps 506 and 508 of process 500, the heat treatment threshold values are entered and stored. These threshold values include one or more of the following: deviant percentage value from any optimal, minimal, maximum or desired parameter, and an interval sampling rate for at least one sensor in the programmable control unit. The programmable control unit is ready for additional computations and/or comparisons that may be requested.

In step 510 of process 500, heat is applied to a workpiece from the heat source.

In step 512, a measurement is taken from one or more sensors at the set interval sampling rate. The measurement(s) is (are) compared to the heat treatment parameter values entered in step 504 and to the calculated values described in steps 506 and 508.

In step 518, at least one exposure value is compared to determine if a threshold value has been exceeded. If a threshold value has not been exceeded, then the process moves to step 516 where the heat treatment continues, while being monitored by process steps 512 and 514, until the set exposure time limit has been reached. If a threshold value has been exceeded, the process continues to step 520 and 522 where the programmable control unit generates and activates a flag corresponding to the associated responsible heat treatment parameter.

In step 524, at least one heat treatment parameter is adjusted. It is one or more of the following: surface temperature of workpiece, exposure time of the workpiece to the heat source, and distance between the workpiece and heat source to correct the heat treatment parameter that caused the flag. The adjustment may be made to the workpiece itself or its surrounding environment as appropriate to make the desired adjustment.

Thus a process according to the present invention is set forth as follows:
(a) inputting for storage a plurality of parameters into a programmable control unit, wherein said plurality of parameters is selected from the group consisting of an optimal surface temperature of said workpiece, a minimum surface temperature of said workpiece, a maximum surface temperature of said workpiece, a target surface temperature of said workpiece, an optimal exposure time of said workpiece to the heat source, a minimum exposure time of said workpiece to the heat source, a maximum exposure time of said workpiece to the heat source, a target exposure time of said workpiece to the heat source, an optimal temperature of said heat source, a minimum temperature of said heat source, a maximum temperature of said heat source, a target temperature of said heat source, an optimal distance between said workpiece and said heat source, a minimum distance between said workpiece and said heat source, a maximum distance between said workpiece and said heat source, a target distance between said workpiece and said heat source, an emissivity value of said workpiece, a deviant percentage value from any optimal, minimal, maximum or desired parameter, and an interval sampling rate for the reading of at least one sensor;
(b) identifying a threshold value of any of the plurality of parameters;
(c) inputting for storage said threshold value into the programmable control unit;
(d) targeting at least one sensor at a workpiece;
(e) applying a heat source to a workpiece;
(f) sampling a corresponding measured value from the sensor at the interval sampling rate;
(g) utilizing the programmable control unit to calculate a differential between the corresponding measured value and the threshold value and determining if the threshold value has been reached; and
(h) and generating a signal when the threshold value has been reached.

In one aspect, the signal generated includes, but is not limited to, digital or paper text, an audible alarm, a visual alarm, a vibratory alarm, combinations thereof, and the like.

In one embodiment, the process further comprises the steps of removing or terminating the heat source from the workpiece and cooling the workpiece.

In one embodiment, the process further comprises the step of adjusting the workpiece or an environment surrounding the workpiece to be within a threshold value by adjusting a condition such as distance from the heat source to the workpiece, intensity of the heat source, the exposure time and combinations thereof.

In accordance with this invention, there is also provided a process for radiation curing a radiation curable material comprising the steps of selecting the heat treatable material that will be applied to the workpiece, identifying the associated reference data, and heat energy required to cure said heat treatable material, and the temperature range of said heat treatable material; applying a heat treatable material coating to a workpiece; positioning a workpiece for application and curing of the heat treatable material coating; calibrating a heat source; focusing a heat source upon the workpiece; focusing a temperature sensor upon the workpiece; focusing a distance sensor upon the workpiece; positioning a heat source at a distance of from about six inches to a few feet from the workpiece; activating the heat source and exposing the workpiece to the heat energy; activating a temperature sensor device and measuring the surface temperature of the workpiece coated with heat treatable coating as the heat energy exposes the workpiece surface; storing the temperature data; activating a distance sensor device and measuring the distance between the surface of the workpiece and the heat source; storing the distance data; retrieving the stored temperature and/or distance data for comparison with the reference data from the first step; determining whether adjustments in the distance or heating properties are necessary; exposing the workpiece with the heat source until the workpiece treatment or curing is completed; and removing the heat source and/or removing the workpiece from its holder.

In accordance with this invention, there is also provided a portable heat treatment device comprising a probe, an infrared cure lamp and a stand. In one embodiment, the heat source comprises a heat gun.

In accordance with this invention, there is also provided a novel device depicted in FIG. 8 for measuring distance and temperature comprising a probe, output interface and a power supply. The probe comprises a first and second sensor, one being adapted for measuring distance and the other being adapted for measuring temperature during heat treating. In one embodiment, probe comprises an aiming laser adapted for guiding and aiding in the focusing of first and second sensors upon a workpiece.

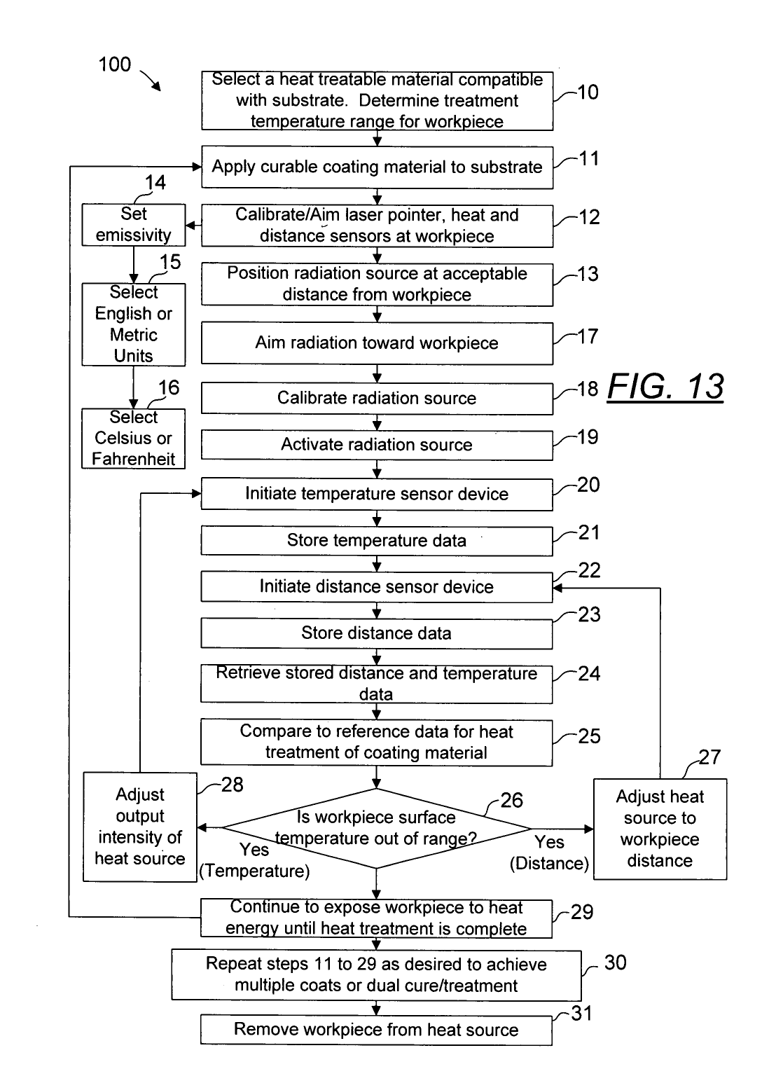

FIG. 13 depicts a novel process for applying heat treatable materials to a workpiece. Referring again to FIG. 13 and step 10 thereof, a user identifies the heat curable material that will be applied to the workpiece, the heat energy required to cure said heat curable material, and the temperature range of said heat curable material.

It is to be understood that process of FIG. 13 will be described in greater detail with respect to infrared curable coatings and infrared radiation sources; however, other heat sources including radiation sources, air heating machines, and heat treatable coatings are considered within the scope of the present invention.

In certain aspects of this process, the energy for UV-curable coatings is generated by low-pressure mercury arc lamps. In certain aspects of this process, energy for EB coatings comes from an electric-heated filament or cathode.

In one aspect of this process, the radiation curable coating consists of from about 2 to about 20, preferably from about 5 to about 15, weight per cent of an initiator. In one embodiment, the initiator comprises a photoinitiator as recited in U.S. Pat. No. 6,905,735 (UV curable paint compositions and method of using same): “Suitable photoinitiators include Irgacure 184 (1-hydroxycyclohexyl phenyl ketone), available commercially from Ciba-Geigy Corp., Tarrytown, N.Y.; CYRACURE UVI-6974 (mixed triaryl sulfonium hexafluoroantimonate salts) and cyracure UVI-6990 (mixed triaryl sulfonium hexafluorophosphate salts) available commercially from Union Carbide Chemicals and Plastics Co. Inc., Danbury, Conn.; and Genocure CQ, Genocure BOK, and Genocure M.F., commercially available from Rahn Radiation Curing. The preferred photoinitiator is Irgacure 1700 commercially available from Ciba-Geigy of Tarrytown, N.Y. Combinations of these materials may also be employed herein.” The entire disclosure of said patent is incorporated by reference into this specification.

In one embodiment, the photocurable coating comprises a coating that is curable by successive exposure to two or more radiation wavelengths. Reference may be made, e.g., to U.S. Pat. No. 5,536,758 (Ultraviolet Radiation Curable Gasket Coating Compositions). The entire disclosure of said patent is incorporated by reference into this specification. In one embodiment, these radiation wavelengths are ultraviolet wavelengths differing by at least 50 nanometers (1.969 microinches).

In one embodiment, photocurable coating comprises a dual cure coating that is curable by successive exposure to ultraviolet radiation wavelengths and thermal radiation energy.

In one embodiment of process of FIG. 13, photocurable coating comprises a high intensity curable resin.

In one embodiment of process of FIG. 13, photocurable coating comprises a material that provides coatings with a thickness of up to about 0.03 centimeters (about 0.01181 inch). In another embodiment, the novel process of this invention may be suitably used with materials that provide coatings with a thickness of up to about 0.05 centimeters (about 0.01969 inch).

In one aspect of this process, photocurable coating comprises a material selected from the group consisting of a dry powder coating, a powder-slurry coating and a wet coating. In one embodiment, the coating is applied in a manner as recited in U.S. Pat. No. 6,905,735 (UV curable paint compositions and method of using same): “The paint composition may be applied to the workpiece using a number of different techniques. The paint composition may be applied, for example, by direct brush application, or it may be sprayed onto the workpiece surface. If automobile undercarriage components are to be coated, the spray technique is particularly useful, in that the components may be spray coated on a conveyor belt type system. The paint composition may also be applied using a screen printing technique. In such screen printing technique, a “screen” as the term is used in the screen printing industry is used to regulate the flow of liquid composition onto the workpiece surface. The paint composition typically would be applied to the screen as the latter contacts the workpiece. The paint composition flows through the silk screen to the workpiece, whereupon it adheres to the workpiece at the desired film thickness. Screen printing techniques suitable for this purpose include known techniques, but wherein the process is adjusted in ways known to persons of ordinary skill in the art to accommodate the viscosity, density, etc. of the liquid-phase composition, and the workpiece of surface properties. Flexographic techniques using pinch rollers to contact the paint composition with a rolling workpiece may be used.” The entire disclosure of said patent is incorporated by reference into this specification.

Referring again to FIG. 13 and step 11 thereof, a radiation curable coating is applied to the workpiece. In one embodiment of process 100, radiation curable coating is applied with a (HVLP) high volume low pressure (from about 5 to about 20 psi, preferably about 10 psi) spray gun. In an electrostatic spraying process the radiation curable coating is electromagnetically charged, while the target workpiece is electrostatically charged with the opposite polarity of the radiation curable coating while it is applied with the electrostatic spray gun. Optionally, the target material may be preheated to promote out-gassing to help eliminate surface contamination prior to applying the radiation curable coating.

In step 12 of process 100, a workpiece is positioned for application and curing of the radiation curable coating. In one aspect, said workpiece is positioned on a holder designed for such purpose. In other aspects, a holder is not required. In one embodiment, the workpiece or workpiece is preferably positioned on the holder such that no portion of the surface to be coated is in contact with the holder and the surface to be coated is facing a radiation source.

In one aspect of this process, the workpiece comprises at least one contoured outer surface. In yet another aspect of this process, the workpiece comprises a substantially flat outer surface.

Referring again to FIG. 13, process 100, the radiation source is calibrated in step 12. In one aspect of this invention where the radiation source comprises an infrared curing device, calibration includes setting the device control 14 to the workpiece emissivity value. In one embodiment, calibration includes setting the control 15 to the English standard or the metric standard involving distance measurements values. In one embodiment, calibration includes setting the control 16 to Fahrenheit or Celsius (metric) temperature measurement data.

Referring again to FIG. 13, process 100, the radiation source is initially placed at a reasonable distance from the workpiece by the operator in step 13. In step 17 the radiation source is focused upon the workpiece such that when radiation waves are emitted from said radiation source, the radiation waves contact the workpiece. In one aspect of this invention, focusing is accomplished with the assistance of a laser pointing device.

Referring again to FIG. 13, process 100, step 18 involves calibrating the radiation source, for example, heat source 206 comprises a plurality of infrared cure lamps, each respectively comprising heating element 220 and a shroud 222 which should all be calibrated to the geometry of the workpiece. In one aspect, the radiation source is preferably positioned in accordance with the manufacturer's recommendations for the coating composition to be applied taking into account that the radiation source is preferably positioned such that the arrays of radiation emitters are at a uniform distance from the workpiece.

In one embodiment of step 18 the radiation source is positioned at a distance of from about 6 inches (about 15.24 centimeters) to a few feet from the workpiece.

In step 19 radiation energy is applied to the workpiece. In one embodiment, the radiation source is an ultraviolet cure lamp with energy intensity settings of, for example, 125 watts, 200 watts, and 300 watts per square inch.” Reference may be made to, e.g., U.S. Pat. No. 6,905,735 (UV curable paint compositions and method of using same). Referring again to FIG. 13, process 100, the radiation source is activated in step 19 and commences emissions of radiation waves. Such radiation waves comprise, e.g., ultraviolet radiation of from about 100 to about 300 nanometers (about 3.937 to about 11.81 microinches), infrared radiation of from about 780 to about 10,000 nanometers (about 30.71 to about 393.7 microinches) or temperatures of from about 100 degrees to about 1200 degrees Fahrenheit (about 648.9 degree Celsius), preferably from about 200 to about 600 degrees Fahrenheit (about 93.33 to about 315.6 degree Celsius), and the like. Such radiation waves are directed toward the workpiece coated with the radiation curable coating.

In step 20, the temperature sensor is focused upon the workpiece from step 18 such that temperature data may be received by the temperature sensor device from the workpiece. In one aspect of this invention, focusing is accomplished with the assistance of a laser. The temperature data received by the temperature sensor is electronically stored in step 21.

Referring again to FIG. 13, process 100, in one aspect of steps 20 and 21, the temperature sensor device comprises a novel device of the present invention.

Referring again to FIG. 13, process 100, in step 22 of process 100, a distance sensor device is activated and measures the distance between the workpiece surface coated with a radiation curable coating and the radiation source, storing the data, e.g., the distance measurement, in step 23.

Referring again to FIG. 13, of process 100, the stored temperature and distance data from steps 21 and 23 is retrieved in step 24, and compared in step 25, with the reference data from step 10 for the radiation curable coating material applied in step 11. In one aspect, the reference data comprises the manufacturer's recommendations for the radiation curable material. In another embodiment, the reference data is based upon a compilation of experience data by the user. In yet another aspect, the reference data comprises the recommendations of an industry expert or an available publication on the application of radiation curable coatings.

Referring again to FIG. 13, in step 26 of process 100, the user determines if adjustments in the distance or output heat intensity are necessary. For example, if the data obtained in step 23 indicated that distance was more than 1 inch (2.54 centimeters), preferably more than 2 inches (5.08 centimeters), deviation from the reference data, then the user would conclude that adjustment of the distance of the radiation source from the workpiece should be made in step 27. For example, if the data obtained in step 21 indicated that temperature was more than 10, preferably more than 25, degrees Fahrenheit, deviation from the reference data, then the user would conclude that adjustment, e.g. increase or decrease of output intensity of the heat source should be made in step 28.

Referring again to FIG. 13, process 100, the temperature and distance measurements may be obtained and compared as many times as necessary to optimize the curing conditions in conformity with the reference data. Thus any or all of steps 20 through 28 may be repeated as necessary or desirable.

When the curing conditions have been optimized, the user proceeds to step 29 wherein the workpiece continues to be exposed to the radiation source until the radiation curable coating is cured. In one aspect of this novel process, step 29 may be carried out in the manner disclosed in U.S. Pat. No. 5,853,215 (Mobile spray booth workstation).

In one aspect of this novel process, step 29 may be carried out in the manner disclosed in U.S. Pat. No. 6,905,735 (UV curable paint compositions and method of using same): “illuminating the paint-containing fluid-phase composition on the workpiece with an ultraviolet light to cause the paint-containing fluid-phase composition to cure into the paint coating. This illumination may be carried out in any number of ways, provided the ultraviolet light or radiation impinges upon the paint composition so that the paint composition is caused to polymerize to form the coating, layer, film, etc. If automotive undercarriage components are to be coated, steps of coating the components by spraying and illuminating the coated parts may be sequentially performed on a conveyor belt type system. Curing preferably takes place by free radical polymerization, which is initiated by an ultraviolet radiation source.”

In another embodiment, the workpiece is successively coated with one or more additional layers of radiation curable coating material as depicted in process 100 of FIG. 13. In step 30, a decision is made whether a dual cure process or additional coatings are desirable. In one embodiment, the workpiece is successively exposed to a different wavelength and/or type of energy, e.g. thermal or ultraviolet (step 30) for a second radiation curing stage.

Referring again to FIG. 13, in step 31 of process 100, when the curing is complete, user removes the radiation source and, if necessary, removes the workpiece from its holder.

### Curing Large Objects

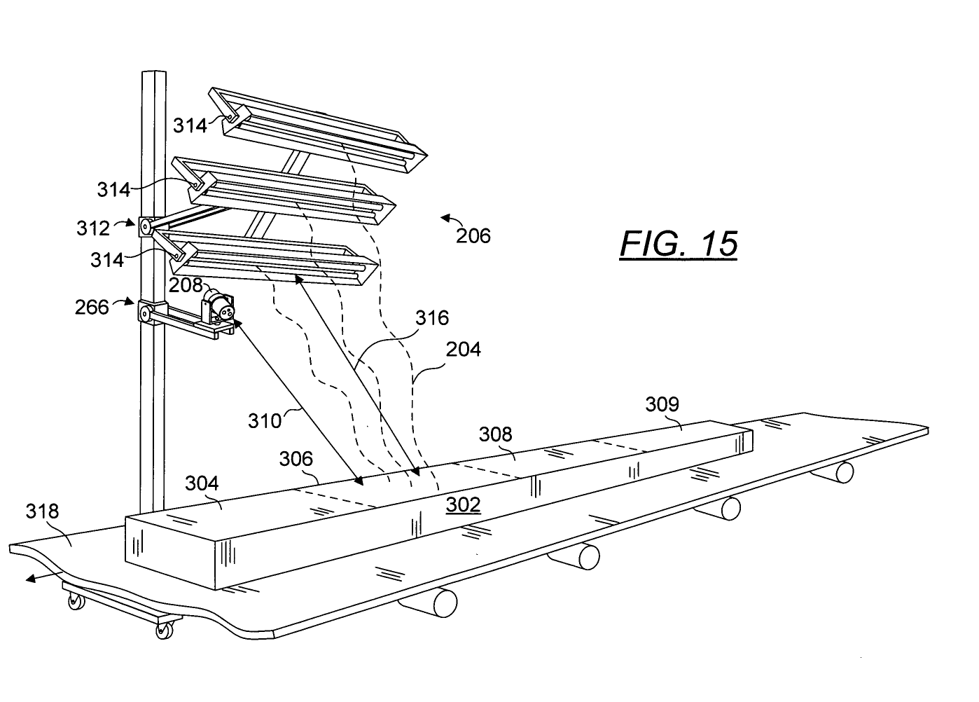

FIG. 15 is an isometric view of the exposing system 200 curing a large workpiece 302. By way of illustration, but not limitation, large workpiece 302 may be a car, dune buggy or any object receiving a radiation curable coating or the like. Large workpiece 302 comprises a first section 304, a second section 306, a third section 308, and a fourth section 309. In the embodiment depicted, a first side of large workpiece 302 is being cured at section 306. Section 304 has already been through the heat treatment process. Sensor probe 208 is disposed at a distance 310 from about 6 inches (about 15.24 centimeters) to about 72 inches (about 182.9 centimeters), preferably from about 6 to about 36 inches (about 15.24 to about 91.44 centimeters). Radiation waves 204 are emitted from the front side of device 206 in the direction of large workpiece 302. It is understood that the system setup and calibration will ensure that the distance from sensor probe 208 to the workpiece 310 will be essentially the same as the heat source to workpiece distance 316.

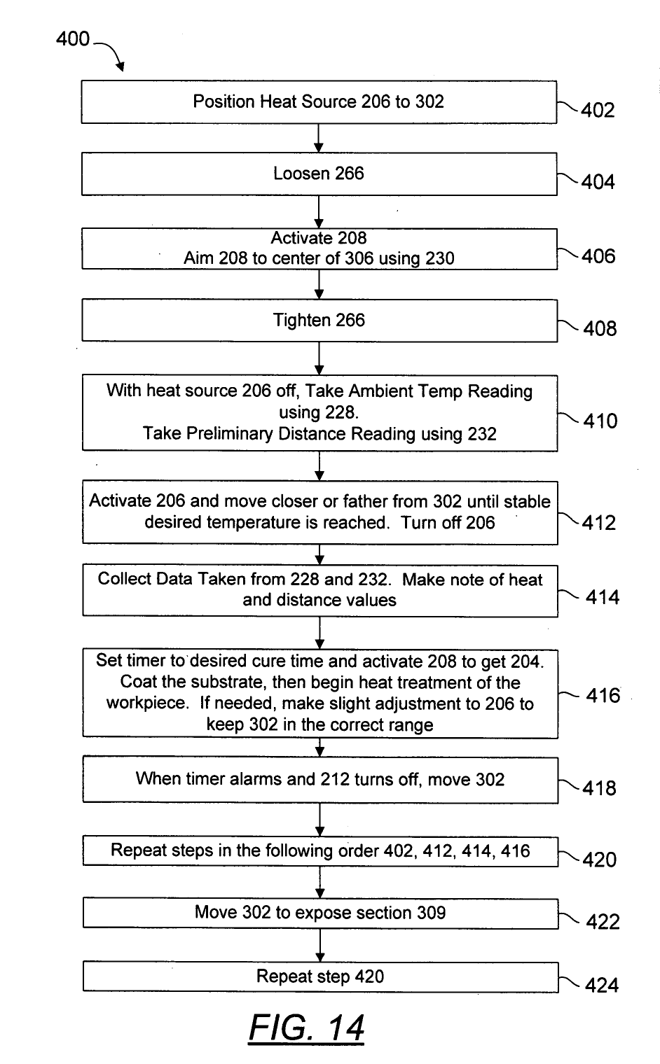

Referring again to FIG. 15, radiation waves are directed toward large workpiece 302 via pivotable adjustable elements 312 and 314. Temperature and distance measurements are made with a sensor probe 208 which includes a temperature sensor 228, a distance sensor 232, laser pointing device 230. FIG. 14 is a schematic representation, a flowchart, of a process 400 for curing large parts by infrared radiation. The process is substantially the same as process 100 extended in sequential repetition to cure successive smaller portions of a larger workpiece. In the embodiment depicted, a novel device of this invention is used to perform some or all of the steps.

Referring to FIG. 14, in step 402 of process 400, a portable radiation source(s) 206 is positioned with respect to second portion 306 of workpiece 302. Workpiece or workpiece 302 has been positioned for application and curing of the radiation curable coating. In one aspect, the workpiece is positioned on a holder 318 designed for such purpose. In one aspect of this process, the workpiece 302 comprises at least one contoured outer surface. In yet another aspect of this process, the workpiece 302 comprises a substantially flat outer surface.

Referring again to FIG. 15, a radiation source 206 is positioned with respect to distance 316 from said workpiece 302. In one aspect, the radiation source 206 is preferably positioned in accordance with the manufacturer's recommendations for the coating composition to be applied. In one aspect, the radiation source 206 is positioned such that the radiation emitter is at a uniform distance 316 from the workpiece 302. In one embodiment, the radiation source 206 is positioned at a distance 316 of from about 6 inches (about 15.24 centimeters) to about 6 feet (about 1.829 meters) from the workpiece 302.

Referring to FIG. 14, the following is achieved in steps 404, 406, and 408 of process 400, pivotable adjustable element 266, as well as probe bracket adjustments dictated by 105 & 109 is used to adjust sensor probe 208 and aim the laser pointing device 230, which provides an aiming function, toward second portion 306 of workpiece 302, which simultaneously aims temperature sensor 228 and distance sensor 232 to the same target. In step 410 of process 400, distance sensor 232 and temperature sensor 228 are activated and directed toward second portion 306 of workpiece 302 to take preliminary distance and ambient temperature readings.

In steps 412, 414, and 416 of process 400, a radiation curable coating is applied to second portion 306 of the workpiece 302. In one embodiment of process 400, radiation curable coating is applied with an electrostatic spraying system. The radiation curable coating is statically charged. The material of the target workpiece 302 is statically charged with the opposite polarity of the radiation curable coating while it is applied with the electrostatic spray gun. Optionally, the target material 302 may be preheated to promote out-gassing to help eliminate surface contamination prior to applying the radiation curable coating.

The radiation source 206 is then calibrated which includes setting the programmable control unit to the proper emissivity. In one embodiment, calibration includes setting the controls to English standard or metric for distance measurement data. In one embodiment, calibration includes setting the controls to Fahrenheit or Celsius (metric) for temperature measurement data.

Referring again to FIG. 14, the radiation source 206 is focused upon the second portion 306 of workpiece 302 in step 416 such that when radiation waves 204 are emitted from said radiation source 206, said radiation waves 204 contact the second portion 306 of workpiece 302.

Referring again to FIG. 14, the radiation source 206 is activated in step 416 and commences emissions of radiation waves 204. Such radiation waves 204 include, but are not limited to: ultraviolet radiation of from about 100 to about 300 nanometers (about 3.937 to about 11.81 microinches), infrared radiation of from about from about 780 to about 10,000 nanometers (about 30.71 to about 393.7 microinches), these sources have the ability to generate surface treatment temperatures from about 100 degrees to about 1200 degrees Fahrenheit (about 648.9 degree Celsius), the preferable range is from about 200 to about 600 degrees Fahrenheit (about 93.33 to about 315.6 degree Celsius). Such radiation waves 204 are directed toward first portion 306 of the workpiece 302 coated with the radiation curable coating.

Referring again to FIG. 14, in step 414 of process 400, a temperature sensor device is activated and measures the surface temperature of the second portion 306 of workpiece 302 coated with radiation curable coating as the radiation waves 204 contact the surface. The temperature reading may be manually recorded or electronically stored. In one aspect of step 414, the temperature sensor device comprises a novel device of the present invention.

Referring again to FIG. 14, in steps 410, 412, and 414 of process 400, a distance sensor device is activated and measures the distance 310 between the surface of the second portion 306 of workpiece 302 coated with radiation curable coating and sensor probe 208. Note that apparatus setup is such that distance 310 approximates distance 316. The distance 310 reading may be manually recorded or electronically stored. In one aspect of steps 410, 412, and 414, the temperature sensor device comprises a novel device of the present invention.

Referring again to FIG. 14, in step 416 of process 400, the manually recorded or electronically stored temperature and distance data from steps 410 and 414 are retrieved for comparison with the reference data for the radiation curable coating material. In one aspect, the reference data comprises the manufacturer's recommendations for the radiation curable material. In another embodiment, the reference data is based upon a compilation of experience data by the user. In yet another aspect, the reference data comprises the recommendations of an industry expert or an available publication on the application of radiation curable coatings. Based upon such comparison, the user determines if adjustments in the distance 310 or intensity of radiation waves 204 are necessary. For example, if the data obtained indicated that distance 310 was more than 12″, preferably more than 14″, deviation from the reference data, and then the user would conclude that adjustment of the distance 316 from the radiation source 206 to the workpiece 306 should be made. For example, if the data obtained indicated that temperature was more than 10, preferably more than 25, degrees Fahrenheit, deviation from the reference data, would alarm the user that adjustment, e.g. increase or decrease the intensity (wattage) of the radiation source is suggested. As will be apparent to those skilled in the art, the user's goal would be to maintain the surface temperature readings within the optimum cure zone for the particular radiation curable coating.

Referring again to FIG. 14, the temperature and distance measurements may be obtained and compared as many times as necessary to optimize the curing conditions in conformity with the reference data. Thus any or all of steps 410, 412, and 414 may be repeated as necessary or desirable.

When the curing conditions have been optimized, the user proceeds to step 418 wherein the second portion 306 of workpiece 302 continues to be exposed to the radiation source until the radiation curable coating is cured. In one aspect of this novel process, step 418 may be carried out with the assistance of a timer. During the curing, any or all of steps 410, 412, and 414 may be repeated as necessary or desirable.

Referring to FIGS. 14 and 15, in step 422 of process 400, the next portion 308 of workpiece 302 to be exposed is positioned under the radiation source 206. Steps 402 through 420 are all repeated as necessary or desirable, and the process continues for fourth portion 309 of workpiece 302, repeating 402 through 420 as necessary or desirable. When the curing of all portions 304, 306, 308, and 309 of workpiece 302 is complete, user removes, or powers off the radiation source 206 and, if necessary, removes the treated workpiece 302 from its holder.

I claim:

1. An apparatus for treating a workpiece with a heat source, said apparatus comprising:
a heat source,
a distance sensor for measuring a distance from said heat source to said workpiece, wherein said distance sensor is operably connected to a programmable control unit, and
a programmable control unit for managing a plurality of exposure parameters operably connected to said heat source, wherein said programmable control unit comprises:
a data input interface for entering workpiece exposure data,
a CPU based logic circuit that defines at least one limit condition based on a plurality of incoming sensor signals and said entered workpiece exposure data, and
a signal generation circuit for generating a signal when said at least one limit condition of the workpiece is exceeded.

2. The apparatus according to claim 1, wherein said heat source comprises a source of temperature controlled air.

3. The apparatus according to claim 1, wherein said heat source comprises a source of adjustable electromagnetic radiation.

4. The apparatus according to claim 1, wherein said distance sensor comprises a laser distance sensor.

5. The apparatus according to claim 1, wherein said workpiece comprises a workpiece surface temperature,
said plurality of exposure parameters comprise said distance between said workpiece and said heat source and said workpiece surface temperature,
said apparatus further comprises a noncontact temperature measuring device for measuring said workpiece surface temperature operably connected to said programmable control unit, and
said plurality of incoming sensor signals comprise said workpiece surface temperature and said distance between said heat source and said workpiece.

6. The apparatus according to claim 5, wherein said noncontact temperature measuring device comprises an infrared sensor.

7. The apparatus according to claim 1, wherein said plurality of exposure parameters further comprises an emissivity value.

8. The apparatus according to claim 7, wherein said emissivity value corrects a noncontact temperature sensor signal to provide a true workpiece surface temperature output reading.

9. The apparatus according to claim 1, wherein said apparatus further comprises a timer circuit that measures a duration of time that said workpiece is subject to a heat treatment process.

10. A programmable control unit assembly for measuring and controlling exposure parameters in a workpiece heat treatment system, said programmable control unit assembly comprising:
a programmable control unit comprising
a data input interface for entering workpiece exposure data;
a CPU based logic circuit that defines at least one limit condition based on at least one incoming sensor signal and said entered workpiece exposure data; and
a signal generation circuit for generating a signal when at least one of said at least one limit condition is exceeded; and
a distance sensor for measuring a distance from a heat source to said workpiece operably connected to said programmable control unit.

11. The programmable control unit assembly according to claim 10, wherein said programmable control unit assembly further comprises a timer circuit that measures a duration of time that said workpiece is subject to a heat treatment process.

12. The programmable control unit assembly according to claim 10, wherein said signal comprises a feedback signal wherein said feedback signal comprises a feedback signal selected from a group consisting of a digital text, a paper text, an audible signal, a visual signal, a vibratory signal, corrective signal, and combinations thereof.

13. The programmable control unit assembly according to claim 10, wherein
said CPU based logic circuit further comprises a memory,
said memory is configured to accept workpiece exposure data from a database,
said database is used by said programmable control unit to identify or define said at least one limit condition,
said programmable control unit calculates a differential between said at least one incoming sensor signal and said at least one limit condition to determine if said limit condition has been reached.

14. The programmable control unit assembly according to claim 10, wherein said programmable control unit further comprises a nonvolatile memory.

15. The programmable control unit assembly according to claim 10, wherein said at least one incoming sensor signal comprises an incoming sensor signal selected from a group consisting of a distance from said heat source to said workpiece, a duration of time that said workpiece is subject to a heat treatment process, a workpiece surface temperature, and combinations thereof.

16. A process for real time controlling of a heat treatment process comprising the steps of:
targeting at least one sensor at a workpiece;
inputting for storage a plurality of parameters into a programmable control unit, wherein said plurality of parameters is selected from a group consisting of an optimal surface temperature of said workpiece, a minimum surface temperature of said workpiece, a maximum surface temperature of said workpiece, a target surface temperature of said workpiece, an optimal exposure time of said workpiece to a heat source, a minimum exposure time of said workpiece to a heat source, a maximum exposure time of said workpiece to a heat source, a target exposure time of said workpiece to a heat source, an optimal temperature of a heat source, a minimum temperature of a heat source, a maximum temperature of a heat source, a target temperature of a heat source, an optimal distance between said workpiece and a heat source, a minimum distance between said workpiece and a heat source, a maximum distance between said workpiece and a heat source, a target distance between said workpiece and a heat source, an emissivity value of said workpiece, a deviant percentage value from any optimal, minimal, maximum or desired parameter, and an interval sampling rate for a reading of said at least one sensor;
identifying a threshold value of any of said plurality of parameters;
inputting for storage said threshold value into said programmable control unit;
applying a heat source to said workpiece;
sampling a corresponding measured value from said sensor at an interval sampling rate;
utilizing said programmable control unit to calculate a differential between said corresponding measured value and said threshold value and determining if said threshold value has been reached; and
generating a signal when said threshold value has been reached.

17. The process according to claim 16, wherein said process further comprises a step of generating a feedback signal wherein said feedback signal comprises a feedback signal selected from a group consisting of a digital text, a paper text, an audible signal, a visual signal, a vibratory signal, corrective signal, and combinations thereof.

18. The process according to claim 17, wherein said process further comprises steps of terminating said heat source and cooling said workpiece.

19. The process according to claim 16, wherein said process further comprises a step of adjusting said workpiece or a workpiece environment to be within said threshold value by adjusting one of said distance from said heat source to said workpiece, an intensity of said heat source, an exposure time, or combinations thereof.

20. An apparatus comprising a laser device for measuring a distance from a heat source to an object and an infrared temperature measuring device for measuring a surface temperature of an object, wherein said apparatus is handheld.
